(19) United States
(12) Patent Application Publication
(10) Pub. No.: US 2025/0337325 A1
(43) Pub. Date: Oct. 30, 2025

(54) POWER SAVING FOR ACCESS POINT

(71) Applicant: HEWLETT PACKARD ENTERPRISE DEVELOPMENT LP, Spring, TX (US)

(72) Inventors: Bo Wang, Beijing (CN); Yue Sun, Beijing (CN)

(21) Appl. No.: 18/650,985

(22) Filed: Apr. 30, 2024

(51) Int. Cl. H02M 3/158; G06F 1/3296

(52) U.S. Cl. CPC H02M 3/158; G06F 1/3296

(57) ABSTRACT

In implementations of the present disclosure, there is provided an approach for saving power for an AP. A method comprises obtaining, by an access point (AP), an environment temperature for the AP. Then, a target working voltage for a front end module (FEM) in the AP is determined based on the environment temperature. Next, the AP determines whether the target working voltage for the FEM is different from an actual working voltage for the FEM output by a voltage regulator in the AP. If the target working voltage is different from the actual working voltage, the voltage regulator is controlled to output the target working voltage. Thus, the AP may control the target working voltage from the voltage regulator to the FEM. Implementations of the present disclosure can reduce the power consumption of the AP when the working voltage for the FEM is adjusted according to the environment temperature.

### BACKGROUND

Access Points (APs) play a crucial role in wireless networks, enabling devices to connect and communicate seamlessly. The APs have high bandwidth. Their power consumption varies based on several factors, including radio frequency (RF) transmission power, a number of connected clients, supported data rates, and hardware's inherent efficiency. To reduce power consumption, various power-saving techniques have been developed for APs.

Power saving is reducing energy consumption to provide the same amount of useful output from a service. It may be implemented by minimizing power consumption under equivalent service conditions. In order to saving power for the APs, intelligent radio transmission management, sleep modes, and the use of energy-efficient hardware and power management techniques are used to reduce the power consumption.

### BRIEF DESCRIPTION OF THE DRAWINGS

Implementations of the present disclosure may be understood from the following Detailed Description when read with the accompanying figures. In accordance with the standard practice in the industry, various features are not drawn to scale. In fact, the dimensions of the various features may be arbitrarily increased or reduced for clarity of discussion. Some examples of the present disclosure are described with respect to the following figures.

FIG. 1 illustrates a block diagram of an example environment in which reference implementations of the present disclosure may be implemented;

FIG. 2 illustrates an example of system architecture of an AP according to implementations of the present disclosure;

FIG. 3 illustrates another example of system architecture of an AP according to implementations of the present disclosure;

FIGS. 4A-4D illustrate examples of adjusting an output voltage according to implementations of the present disclosure;

FIG. 5 illustrates an example of working voltages for different scenarios according to implementations of the present disclosure;

FIG. 6 illustrates an example of key circuits for the AP according to implementations of the present disclosure;

FIG. 7 illustrates an example of simulation result for the AP according to implementations of the present disclosure;

FIG. 8 illustrates a flow chart of an example method for saving power according to implementations of the present disclosure; and

FIG. 9 illustrates an example access point device according to implementations of the present disclosure.

### DETAILED DESCRIPTION

As discussed above, the power consumption is still high and the power saving for the APs needs to be further improved. For example, the utilization of the 6G band has led to an increase in the number of front end modules (FEMs) in an AP. Therefore, the overall power consumption for the AP is increased. Moreover, the AP employs a filter bank mode, which offers the advantage of simplifying filter design by reducing filter bandwidth, thereby supporting flexible and reliable configuration modes for the AP.

However, different filters have different insertion losses due to their distinct isolation requirements. To meet transmit power requirement of the full band, high-power FEMs with maximum voltage are used to solve the problem caused by the insertion losses. Further, the output power for FEM is temperature-dependent. The maximum voltage for the FEM must be selected to deliver the appropriate output power at any temperature. In summary, the power consumption of the AP is increased.

Therefore, implementations of the present disclosure propose a solution for saving power of an AP. According to implementations of the present disclosure, the AP may obtain an environment temperature for the AP. Then, the AP may further use the environment temperature to determine a target working voltage, which is suitable for a FEM in the AP. Next, the AP may obtain an actual working voltage for the FEM output by a voltage regulator in the AP, and compare the target working voltage for the FEM and the actual working voltage for the FEM. If the AP determines that the target working voltage for the FEM is different from an actual working voltage for the FEM, the AP may control the voltage regulator to output the target working voltage. Then the target working voltage is provided to the FEM from the voltage regulator.

As discussed above, the AP needs to obtain an environment temperature for the AP and uses the obtained environment temperature to determine a target working voltage used by the FEM in the AP. Therefore, the FEM may use the target working voltage to work by controlling the voltage regulator in the AP to output the target working voltage. It can be seen that, the working voltage for the FEM is not fixed and may change depending on the environment temperature. Therefore, for different working scenarios, the AP may provide different working voltages to the FEM, rather than providing the maximum working voltage that is suitable for all scenarios. For example, in a scenario with a lower temperature, the FEM may use a lower working voltage to work, rather than using the higher working voltage that is used in any scenario. Therefore, the power consumption for the FEM may be reduced when the AP works at the lower temperature. Thereby, the power saving for the AP is achieved.

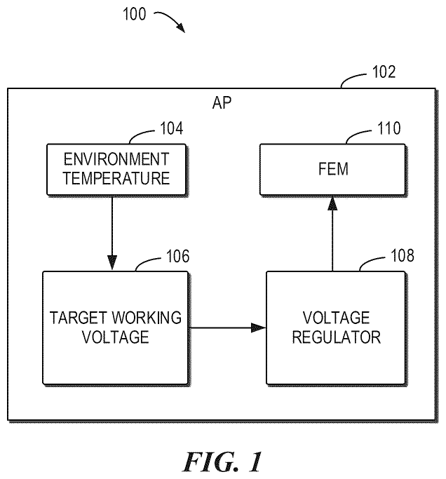

Other advantages of implementations of the present disclosure will be described with reference to the reference implementations as described below. Reference is made below to FIG. 1 through FIG. 9 to illustrate basic principles and several reference implementations of the present disclosure herein.

FIG. 1 shows a block diagram of an example environment in which reference implementations of the present disclosure may be implemented. In the example environment 100 of FIG. 1, An AP 102 includes a FEM 110 and a voltage regulator 108.

The FEM 110 is an integrated circuit (IC) or a subassembly in the AP. It serves as the interface between the radio frequency (RF) signals and the digital circuitry within the AP. The primary functions of the FEM in the AP include signal amplification, filtering, and switching, which are essential for ensuring reliable and efficient wireless communication. FIG. 1 shows that the AP 102 includes one FEM, which is an example, rather than the limitation to the disclosure. In some implementations, the AP 102 may include a plurality of FEMs.

In the AP, the FEM 110 is powered by the voltage regulator 108. The output voltage of the voltage regulator 108 is used as the working voltage of the FEM 110. The voltage regulator 108 may receive a voltage which is higher than the working voltage provided to the FEM 110. Therefore, the voltage regulator 108 may adjust the received voltage to the working voltage suitable for the FEM 110. For example, the voltage regulator 108 may receive a voltage of 12V and output a working voltage of 4V suitable for the FEM 110. In some implementations, the voltage regulator 108 is powered by a power over Ethernet (POE) circuit. In some implementations, the voltage regulator 108 is powered by a power supply unit.

Generally, the FEM is supplied with a predetermined working voltage provided by the voltage regulator 108. In fact, the predetermined working voltage for the FEM 110 is a maximum working voltage for the FEM which allows the FEM to work normally in any scenario. In this disclosure, it is noticed that when the AP works at a higher environment temperature, the predetermined working voltage is required by the FEM 110, and when the environment temperature is lower, the working voltage for FEM may be reduced. In order to save power, the AP 102 may adjust the working voltage for FEM 110 based on the environment temperature.

In order to adjust the working voltage for the FEM according to the environment temperature, the AP needs to determine an environment temperature 104 when the AP is working. In some implementations, the AP 102 may include a temperature sensor which is used to detect the environment temperature. The temperature sensor may detect the temperature of the working environment in real-time. In some implementations, the environment temperature may be received by the AP 102 from other devices, for example, an upper controller of the AP 102. The above examples are used to describe the disclosure, rather than the limitation to the disclosure.

Next, the AP 102 would determine a target working voltage for the FEM 110 according to the environment temperature 104. The AP may obtain a pre-established mapping between temperatures and working voltages for the FEM. For example, the AP may receive the mapping between temperatures and working voltages for the FEM from the upper controller. Therefore, the AP may use the mapping between temperatures and working voltages for the FEM to determine the target working voltage for the FEM 110.

In some implementations, the mapping between the temperatures and the working voltages typically consists of a plurality of temperature ranges, each associated with a specific working voltage. For example, each of a plurality of temperature ranges is 15°, and each temperature range corresponds to a working voltage. It may be shown in the following table.

Table 1 shows the mapping between the temperature ranges and the working voltages

| Temperature range | Working voltage |
|---|---|
| 10°-25° | 4.0 V |
| 25°-40° | 4.1 V |
| 40°-55° | 4.2 V |
| 55°-70° | 4.3 V |
| 70°-85° | 4.4 V |

Table 1 is used to illustrate the example, rather than the limitation to the disclosure. The temperature range may be set as any suitable value and working voltage also may be set as any suitable value. For example, the temperature range may be set as 10°.

In this case, when the AP 102 obtains the environment temperature 104, the AP searches for the temperature range including the environment temperature 104 from the plurality of temperature ranges, then uses the working voltage corresponding to the searched temperature range in the mapping as the target working voltage 106.

In some implementations, the mapping between the temperatures and the working voltages is the corresponding relationship between the temperature and the working voltage. In this case, when the AP obtains the environment temperature 104, the AP searches for a working voltage corresponding to the environment temperature 104 in the mapping as the target working voltage. In some implementations, the mapping between the temperatures and the working voltages is a function. In this case, when the AP obtains the environment temperature 104, the AP uses the function to calculate the target working voltage. The above examples are used to illustrate this disclosure, rather than the limitation to the disclosure.

After the AP obtains the target working voltage 106, the AP 102 may further obtain the actual working voltage of the FEM 110. The AP 102 compares the target working voltage for the FEM 110 and the actual working voltage for the FEM 110. If the target working voltage 106 for the FEM 110 is the same as the actual working voltage for the FEM 110, it shows that the working voltage provided to the FEM is appropriate and the AP 102 would not adjust the actual working voltage of the FEM 110. If the target working voltage 106 for the FEM 110 is different from the actual working voltage for the FEM 110, it shows that the actual working voltage provided to the FEM 110 is improper and the AP would adjust the working voltage of the FEM 110.

When the working voltage of the FEM 110 needs to be adjusted, the AP 102 would control the voltage regulator 108 to adjust the output voltage of the voltage regulator 108. In one example, the voltage regulator 108 is a buck convert. In another example, the voltage regulator 108 is a direct current to direct current (DC-DC) converter.

The voltage regulator 108 may receive a feedback voltage. For example, the voltage regulator 108 has a feedback voltage pin. This feedback voltage pin plays a critical role in the closed-loop control mechanism of the voltage regulator 108, ensuring that the output voltage remains constant despite variations in input voltage, load current, or other external factors. Generally, the feedback voltage is fixed and. is provided to the feedback voltage pin of the voltage regulator 108. However, if the feedback voltage provided to the feedback voltage pin is changed, the output voltage of the voltage regulator 100 that is provided to the FEM 110 will be changed.

In order to adjust the output voltage of the voltage regulator 108, the AP 102 adjusts the feedback voltage provided to the feedback pin of the voltage regulator 108. As discussed above, if the target working voltage for the FEM 110 is different from the current working voltage for the FEM 110, it shows that the current working voltage provided to the FEM 110 is improper. In this case, the AP 102 would adjust the output voltage of the voltage regulator 108 by adjusting the feedback voltage provided to the feedback pin in the voltage regulator 108.

In some implementations, if the target working voltage required by the FEM 110 is higher than the actual working voltage for the FEM 110, the AP may reduce a feedback voltage provided to the voltage regulator 108. In this case, the voltage regulator 108 may detect that the feedback voltage received via the feedback pin is reduced. In order to maintain the fixed voltage, the voltage regulator 108 needs to increase the output voltage, thereby increasing the working voltage of the FEM 110 until the working voltage is the same as the target working voltage. If the target working voltage required by the FEM 110 is lower than the actual working voltage for the FEM 110, the AP may increase a feedback voltage provided to the voltage regulator 108. In this case, the voltage regulator 108 detects that the feedback voltage received via the feedback pin is increased. In order to maintain the fixed voltage, the voltage regulator needs to reduce the output voltage, thereby reducing the working voltage of the FEM 110 until the working voltage is the same as the target working voltage.

Therefore, the working voltage provided to the FEM 110 may be varied according to the environment temperature. For example, when the environment temperature is 85°, the working voltage for the FEM may be adjusted to be 4.4V; and when the environment temperature is 25°, the working voltage for the FEM may be adjusted to be 4.0V. Thus, when the environment temperature is lower, the lower working voltage is used by the FEM. Therefore, the power consumption is reduced and the power saving is implemented.

In some implementations, the AP may include a plurality of FEMs and the plurality of FEMs may receive the working voltages from the voltage regulator. In this case, the working voltages for the plurality of FEMs also may be adjusted by the AP according to the environment temperature.

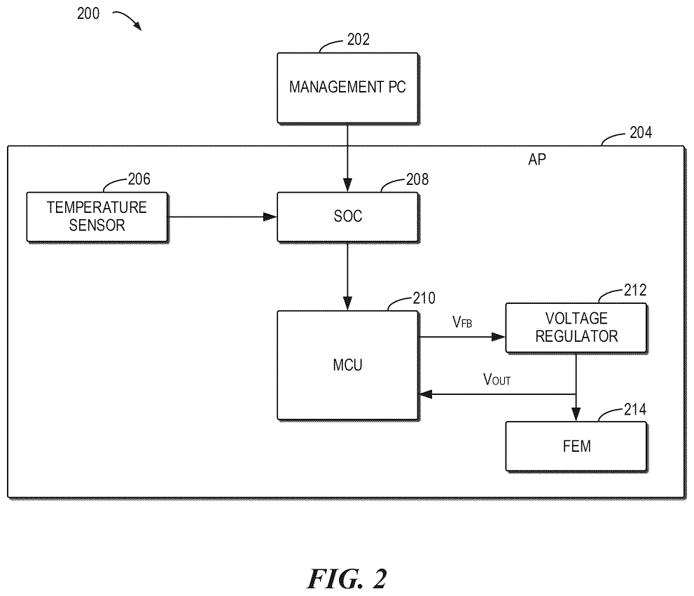

FIG. 2 shows an example 200 of system architecture of an AP according to implementations of the present disclosure. In the example 200, there is a management personal computer (PC) 202 and an AP 204. The AP 204 may be an example of the AP 102 in FIG. 1. The management PC 202 may communicate with the AP 204 to configure the AP 204. For example, the management PC 202 may configure the AP 204 to operate on a specific frequency band, in a particular country, with a designated username and password, as well as determine the number of radios to activate and an operating power.

The AP 204 includes a system on chip (SoC) 208. The SoC 208 in the AP 204 is an integrated circuit that consolidates multiple key functional blocks required for the operation of the AP 102, specifically designed to serve as a central hub for connecting client devices to a wired network or the internet. By incorporating these functionalities into a single chip, the SoC 208 in the AP 102 offers high performance, energy efficiency, and compact form factors, making it suitable for a wide range of deployment scenarios, including enterprise, residential, and industrial environments.

The AP 204 includes a temperature sensor 206, which is used to detect the environment temperature when the AP works. Therefore, the temperature sensor 206 may obtain an environment temperature of the AP in real-time and transmit the environment temperature to the SOC 208.

The SoC 208 may receive the environment temperature and is capable of utilizing the environmental temperature to determine a target working voltage for the FEM 214 based on a pre-established mapping between temperatures and corresponding working voltages for the FEM 214. This temperature-aware voltage regulation mechanism ensures optimal FEM performance, enhances reliability, and prolongs the overall lifetime of the AP.

Then, the SoC 208 may transmit the target working voltage to a Microcontroller Unit (MCU) 210. The MCU 210 may communicate with the voltage regulator 212. Therefore, the MCU 210 may also detect the actual or current working voltage Vₒᵤₜ provided by a voltage regulator 212 to the FEM 214. The MCU 210 further compares the target working voltage for the FEM 214 and the current working voltage for the FEM 214. If the target working voltage for the FEM 214 is the same as the current working voltage for the FEM 214, the MCU 210 would not control the voltage regulator 212 to change the current working voltage for the FEM 214. If the target working voltage for the FEM 214 is different from the current working voltage for the FEM 214, the MCU 210 would control the voltage regulator 212 to change the current working voltage provided to the FEM 214.

The voltage regulator 212 is used to provide the output voltage as the working voltage of the FEM 214. For example, the voltage regulator 212 may provide a voltage of 4.4v to the FEM as the working voltage. The voltage regulator 212 includes a feedback voltage pin. The output voltage of the voltage regulator 212 may be adjusted by changing the feedback voltage provided to the feedback voltage pin.

In order to adjust the output voltage of the voltage regulator, the MCU 210 may connect to the feedback pin of the voltage regulator 212. As discussed above, when the target working voltage for the FEM 212 is different from the current working voltage provided to the FEM 214, the current working voltage provided to the FEM 214 needs to be adjusted. In this case, the MCU 210 would adjust the feedback voltage provided to the feedback voltage pin in the voltage regulator 212 to adjust the output voltage of the voltage regulator 212.

Therefore, if the target working voltage required by the FEM 214 is higher than the actual working voltage for the FEM 214, the MCU 210 may gradually reduce a feedback voltage provided to the feedback voltage pin of the voltage regulator 212. For example, the feedback voltage may be reduced by 0.1 V. When the voltage regulator 212 detects that the received feedback voltage is reduced. The voltage regulator 212 needs to increase the output voltage of the voltage regulator 212, thereby the working voltage of the FEM 214 is increased. At the same time, the MCU 210 continues to monitor the output voltage of the voltage regulator 212. If the monitored output voltage of the voltage regulator 212 or the working voltage of the FEM 214 is still lower than the target working voltage, the MCU 210 continues to reduce the feedback voltage provided to the feedback voltage pin of the voltage regulator 212 until the working voltage of the FEM 214 is the same as the target working voltage of the FEM 214.

If the target working voltage required by the FEM 214 is lower than the actual working voltage for the FEM 214, the MCU 210 may gradually increase a feedback voltage provided to the feedback voltage pin of the voltage regulator 212. For example, the feedback voltage may be increased by 0.1 V. When the voltage regulator 212 detects that the received feedback voltage is increased. The voltage regulator 212 needs to reduce the output voltage of the voltage regulator 212, thereby the working voltage of the FEM 214 is reduced. At the same time, the MCU 210 monitors the output voltage of the voltage regulator 212 in real-time. If the monitored output voltage of the voltage regulator 212 or the working voltage of the FEM 214 is still higher than the target working voltage, the MCU 219 continues to increase the feedback voltage provided to the feedback voltage pin of the voltage regulator 212 until the working voltage of the FEM 214 is the same as the target working voltage of the FEM 214.

Therefore, the working voltage provided to the FEM 214 may be varied according to the environment temperature. In some implementations, the MCU 210 may obtain the environment temperature directly. In one example, the MCU 210 receives the environment temperature from the SoC 208. In another example, the MCU 210 receives the environment temperature from the temperature sensor 206. In this case, the MCU 210 may utilize the environmental temperature to determine a target working voltage for the FEM 214 based on a pre-established mapping between temperatures and working voltages for the FEM.

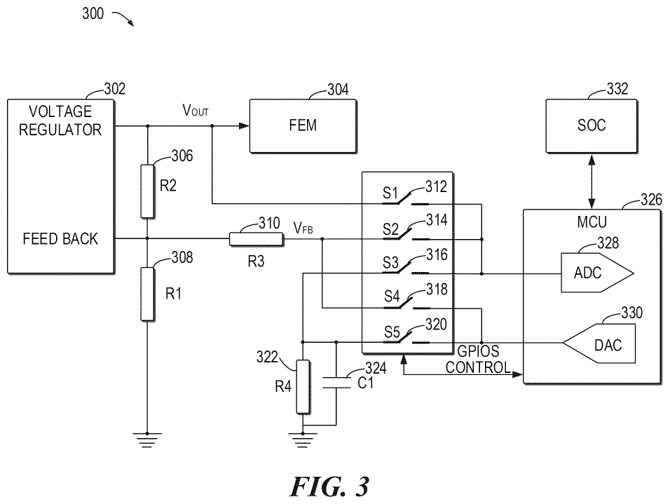

FIG. 3 shows another example 300 of system architecture of an AP according to implementations of the present disclosure. The system architecture may be an example of the AP 102 in FIG. 1 or the AP 204 in FIG. 2. In the example 300, there is a voltage regulator 302, which outputs an output voltage Vₒᵤₜ to the FEM 304 as the working voltage of the FEM 304. For example, the FEM 304 may use the received working voltage to process signals.

The voltage regulator 302 has a feedback voltage pin, which may receive the feedback voltage. The voltage regulator 302 connects with an electrical resistance 306 and an electrical resistance 308. The electrical resistance 306 and the electrical resistance 308 are connected in series and may be used to determine the output voltage Vₒᵤₜ of the voltage regulator 302 and the feedback voltage V_{fb} received by the feedback voltage pin. In order to describe easily, the electrical resistance 306 and the electrical resistance 308 may be referred to as R1 and R2. The relationship between the electrical resistance 306 and the electrical resistance 308 may be determined based on the following equation (1), which is a design formula of power supply.

$$R 2 = \frac{{V}_{o u t} - {V}_{fb}}{{V}_{fb}} * R 1 \qquad ( 1 )$$

Therefore, the feedback voltage V_{fb} from the desired voltage Vₒᵤₜ may be determined based on the following equation (2).

$${V}_{fb} = \frac{{V}_{o u t} * R 1}{R 1 + R 2} \qquad ( 2 )$$

Next, the desired output voltage Vₒᵤₜ may be determined based on the following equation (3).

$${V}_{out} = \frac{{V}_{fb} ( R 1 + R 2 )}{R 1} \qquad ( 3 )$$

From the above three equations, it can be seen that the feedback voltage provided to the voltage regulator 302 and the output voltage of the voltage regulator 302 may be determined by the electrical resistance 306 and the electrical resistance 308. After the electrical resistance 306 and the electrical resistance 308 is determined, the feedback voltage provided to the voltage regulator 302 and the output voltage of the voltage regulator 302 are also determined.

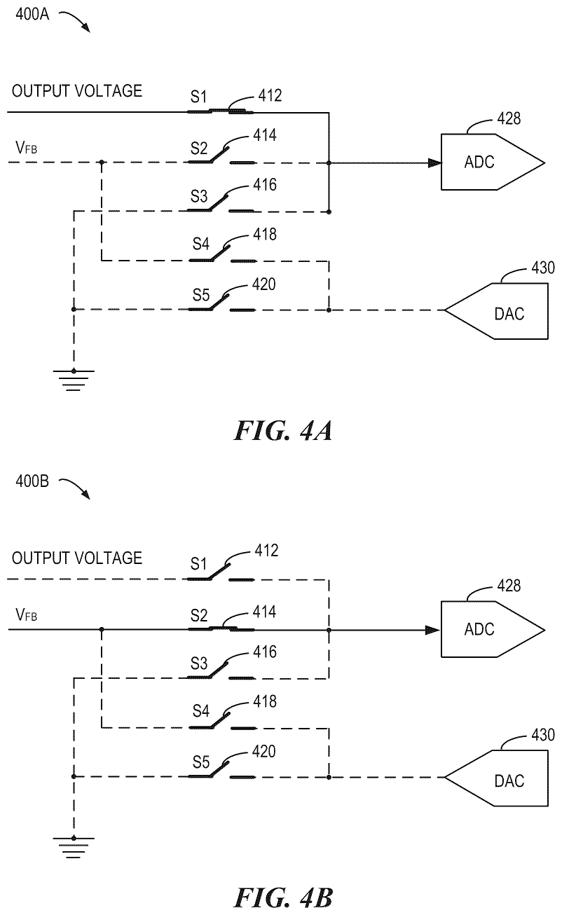

In order to adjust the output voltage of the voltage regulator 302, the MCU 326 and five switches 312, 314, 316, 318, and 320 are setup in the AP. The MCU 326 includes an analog-to-digital converter (ADC) 328 and a digital-to-analog converter (DAC) 330. The ADC 328 is used to detect voltages and the DAC 330 is used to provide voltages. When the AP works, the MCU 326 may control some of the five switches 312, 314, 316, 318, and 320 to input the output voltage of voltage regulator 302 into the ADC 328 and to provide the output voltage of the DAC 330 to the feedback voltage pin of the voltage regulator 302 as the feedback voltage. Therefore, the MCU 326 may adjust the feedback voltage provided to the feedback pin of the voltage regulator 302 to control the output voltage of the voltage regulator 302. The working process regarding the MCU 326 and the five switches will be described with reference to FIGS. 4A, 4B, 4C, and 4D.

In the example 300, an SoC 332 may communicate with the MCU 326. The SoC 332 obtains an environment temperature from a temperature sensor and determines a target working voltage for the FEM 304 according to the environment temperature. The SoC 332 also provides the target working voltage to the MCU 326. Then, the MCU 326 may change the output voltage of the DAC 330 according to the target working voltage, thereby adjusting the feedback voltage provided to the feedback voltage pin in the voltage regulator 302. The MCU 326 may use the general purpose inputs/outputs (GPIOs) control signal to control the five switches. In the AP, there is an electrical resistance 322 and a capacitor 324. When the switch 316 and the switch 320 is on, the electrical resistance 322 is used as the load and the capacitor 324 is used to provide stability. Additionally, the electrical resistance 310 is provided to help to adjust the feedback voltage.

FIGS. 4A-4D illustrate examples of adjusting an output voltage according to implementations of the present disclosure. The examples in FIGS. 4A-4D are used to describe the working process of the ADC 328, DAC 330, and five switches in FIG. 3. Therefore, the ADC 428, DAC 430 and five switches in FIGS. 4A-4D corresponds to the ADC 328, DAC 330, and five switches in FIG. 3. As shown in example 400A of FIG. 4A, the switch 412 is closed and the other switches are opened. In this case, the ADC 428 is connected to the output of the voltage regulator, and no other devices are connected to the ADC 428. Therefore, the ADC 428 may be used to detect the actual output voltage of the voltage regulator. Additionally, the MCU may save the detected output voltage of the voltage regulator.

Next, as shown in example 400B of FIG. 4B, the switch 412 is opened and the switch 414 is closed. In this case, the ADC 428 is connected to the feedback voltage pin of the voltage regulator. Therefore, the ADC 428 may be used to detect the feedback voltage for the voltage regulator. Additionally, the MCU may save the detected feedback voltage. After the feedback voltage for the feedback voltage pin is detected, the MCU may further set the output voltage of the DAC 430 to be the feedback voltage.

As shown in example 400C of FIG. 4C, the switch 414 is opened and the switch 416 and the switch 420 are closed. In this case, the ADC 428 is connected to the output of the DAC 430. As discussed above, the ADC 428 has detected the feedback voltage. Therefore, after the ADC 428 is connected to the output of the DAC 430, the MCU may increase the output voltage of the DAC 430. Then, the ADC 428 is used to detect the increased output voltage of the DAC 430. When the output voltage of the DAC 430 detected by the ADC reaches the feedback voltage, the MCU would not increase the output voltage of the DAC 430 and maintain the output voltage of the DAC 430 as the feedback voltage. The purpose of maintaining the output voltage of the DAC as the feedback voltage is to avoid sharp changes in the feedback voltage provided to the feedback voltage pin of the voltage regulator when the DAC is connected to the feedback pin.

As shown in example 400D of FIG. 4D, the switches 416 and 420 are opened and the switch 412 and the switch 418 are closed. In this case, the ADC 428 is connected to the output of the voltage regulator. Therefore, the ADC 428 may detect the output voltage of the voltage regulator. Moreover, the switch 418 may connect the DAC to the feedback voltage pin of the voltage regulator. In the initial phase, because the output voltage of the DAC 430 is adjusted to be the feedback voltage of the voltage regulator, the output voltage detected by the ADC 428 would not be changed.

When the SoC obtains the environment temperature, the SoC may use the environment temperature to determine the target working voltage for the FEM or the target output voltage of the voltage regulator according to the environment temperature. Then, the SoC provides the target working voltage to the MCU. Then, the MCU would compare the current output voltage obtained by the ADC 428 with the target working voltage. If the current output voltage detected by the ADC 428 is equal to the target working voltage determined by SoC, the MCU would not change the output voltage of the DAC 430. If the current output voltage detected by the ADC 428 is different from the target working voltage, the MCU will control the DAC 430 to adjust the output voltage of the DAC 430. In this case, the MCU gradually adjusts the output voltage. Moreover, the ADC 428 is used to detect the changed output voltage of the voltage regulator while the output voltage of the DAC 430 is changed. When the working voltage of the voltage regulator detected by the ADC 428 is equal to the target working voltage, the MCU stops adjusting the output voltage of the DAC 430.

In some implementations, if the output voltage detected by the ADC 428 is lower than the target working voltage, the MCU will gradually reduce the output voltage of the DAC 430. In this case, the feedback voltage provided by the DAC to the feedback pin of the voltage regulator would be reduced. Therefore, the voltage regulator would increase the output voltage. If the output voltage detected by the ADC 428 is higher than the target working voltage, the MCU will gradually increase the output voltage of the DAC 430. In this case, the feedback voltage provided by the DAC 430 to the feedback pin of the voltage regulator would be increased. Therefore, with the ADC 428 and the DAC 430, the MCU may adjust the actual working voltage of the FEM to be the target working voltage.

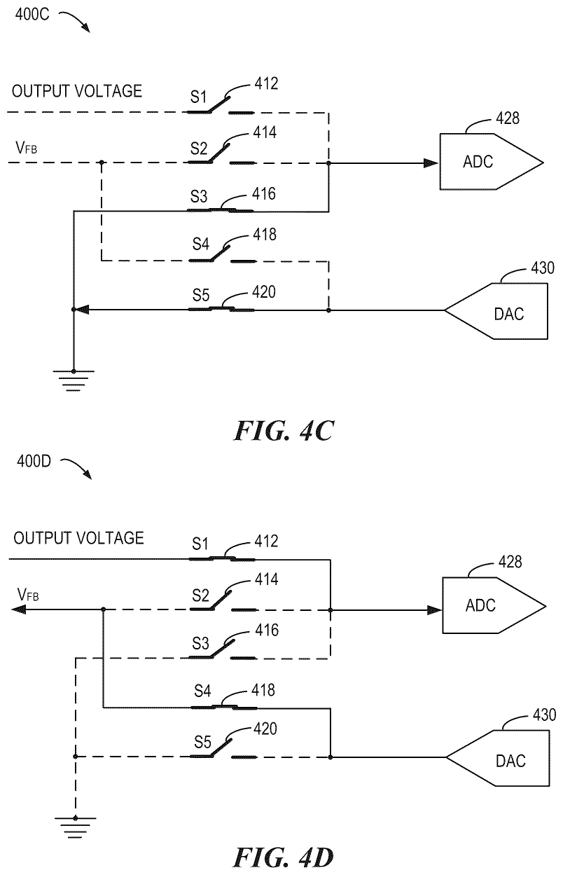

FIG. 5 illustrates an example of working voltages for different scenarios according to implementations of the present disclosure. In example 500, it shows that when the FEM works on different channels, the different voltages are required for different environment temperatures. For example, when the FEM works on the 6G_N_channel 1 and the environment temperature is 55°, the working voltage for the FEM is 4.4V. When the FEM works on the 6G_W_channel 100 and the environment temperature is 55°, the working voltage for the FEM is 4.2V. When the FEM works on the 6G_L_channel and the environment temperature is 20°, the working voltage for the FEM is 4.0V. It can be seen that, when the FEM works on different channels and in different environment temperate, the working voltage for the FEM may be different. Therefore, the working voltage for the FEM may be adjusted based on the environment temperature.

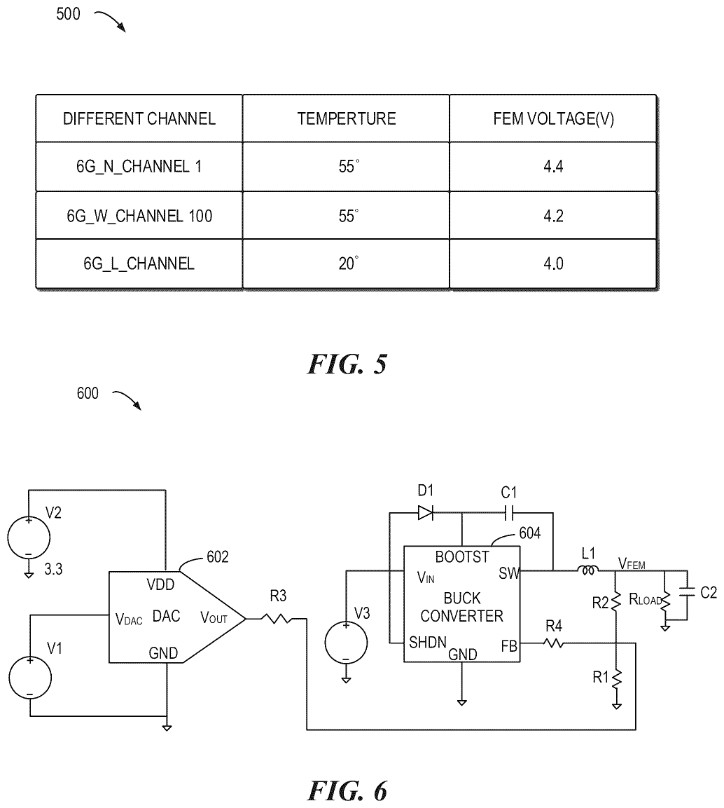

FIG. 6 illustrates an example of key circuits for the AP according to implementations of the present disclosure. In example 600, there is a simulation of the key circuits of the AP. In this example, the main components of the AP are shown. For example, the DAC 602 and the buck converter 604 are shown. The buck converter 604 is an example voltage regulator. The Road may be viewed as the FEM of the AP. The buck converter is used to provide the output voltage to the R_{load}. The output Vₒᵤₜ of the DAC 602 is connected to the feedback voltage pin of the buck converter.

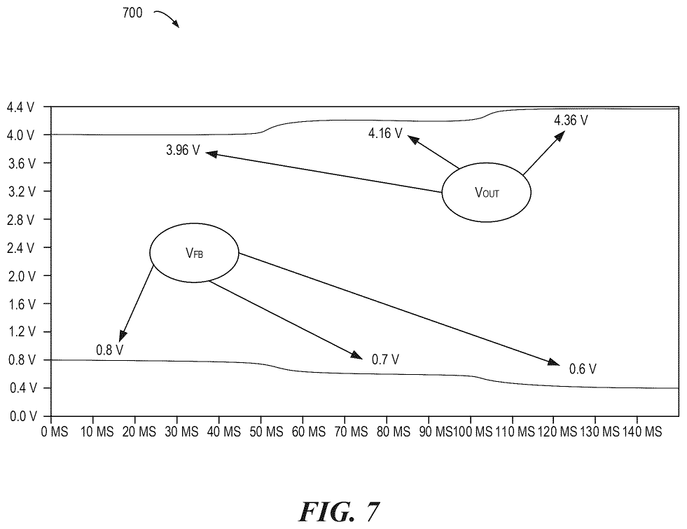

FIG. 7 illustrates an example of a simulation result for the AP according to implementations of the present disclosure. In example 700, the feedback voltage is originally set as 0.8V. After a period of time, the feedback voltage is changed to 0.7V and then at last, the feedback voltage is changed to 0.6V. It can be seen from FIG. 7 that the output voltage of the voltage regulator is changed with the feedback voltage changes. When the feedback voltage for the voltage regulator is 0.8V, the output voltage of the voltage regulator is about 3.96V. After the feedback voltage for the voltage regulator is reduced to 0.7V, the output voltage of the voltage regulator is increased to 4.16V. Next, when the feedback voltage for the voltage regulator is further reduced to 0.6V, the output voltage of the voltage regulator continues to increase to 4.36V. Therefore, the output voltage of the voltage regulator increases when the feedback voltage provided to the voltage regulator reduces.

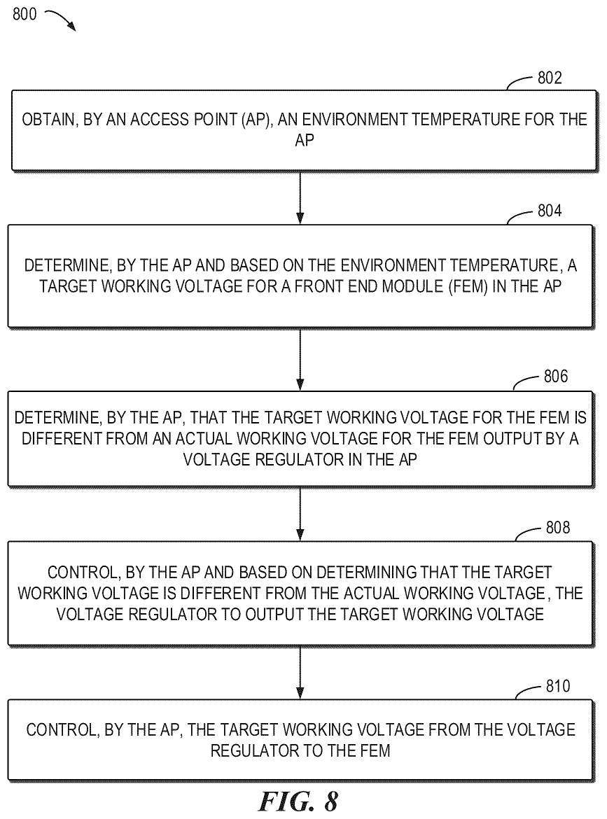

FIG. 8 illustrates a flow chart of an example method for saving power according to implementations of the present disclosure, and the method 800 is performed by an AP. At 802, the AP obtains an environment temperature for the AP. For example, the AP includes a temperature sensor and the temperature sensor is used to detect an environment temperature. The environment temperature may be used to adjust the working voltage provided to the FEM.

At 804, the AP determines, based on the environment temperature, a target working voltage for a front end module (FEM) in the AP. For example, in order to obtain a target working voltage for the FEM, the AP 102 may obtain a mapping between working voltages for the FEM and environment temperatures in the scenarios where the AP works. Then, the AP may obtain the target working voltage for the FEM from the mapping between working voltages for the FEM and environment temperatures.

At 806, the AP determines that the target working voltage for the FEM is different from an actual working voltage for the FEM output by a voltage regulator in the AP. In order to reduce power consumption, the AP needs to determine whether the AP works in the target working voltage. Therefore, the AP also needs to detect the actual working voltage of the FEM. A voltage detection unit is set in the AP to detect the current working voltage of the FEM.

For example, as discussed above, the voltage detection unit may be an ADC and the voltage detection unit may be connected to the output port of the voltage regulator. Thus, the voltage detection unit may be used to detect the output voltage of the voltage regulator. In some implementations, the AP further compares the target working voltage for the FEM and the actual working voltage for the FEM. Then, the AP determines how to adjust the current working voltage according to the comparison.

At 808, the AP controls, based on determining that the target working voltage is different from the actual working voltage, the voltage regulator to output the target working voltage. For example, the AP 102 needs to adjust the voltage regulator to out the target working voltage if the target working voltage for the FEM is different from the actual working voltage for the FEM.

In some implementations, the voltage regulator may receive feedback voltage and adjust the output voltage output by the voltage regulator according to the feedback voltage. The AP may control the feedback voltage provided to the voltage regulator with an MCU. For example, if the feedback voltage received by the voltage regulator is reduced, the output voltage output by the voltage regulator will be increased; and if the feedback voltage received by the voltage regulator is increased, the output voltage of the voltage regulator will be reduced.

Therefore, if the target working voltage is higher than the actual working voltage, the AP may reduce the feedback voltage provided to the voltage regulator. Thus, the output voltage of the voltage regulator may be increased to the target working voltage. If the target working voltage is lower than the actual working voltage, the AP may increase the feedback voltage provided to the voltage regulator. In this case, the output voltage of the voltage regulator may be reduced to the target working voltage.

At 810, the AP controls the target working voltage from the voltage regulator to the FEM. For example, the AP 102 may provide the target working voltage to the FEM 110. The FEM 110 uses the target working voltage to process signal. For example, in the lower temperature environment, the FEM may use the lower working voltage.

In this way, the AP may determine a target working voltage according to the environment temperature. When the temperature is lower, the FEM may use a lower working voltage to work. Therefore, the power consumed by the FEM will be reduced when the temperature is lower. Thereby, the power efficiency is improved and the power consumption for the AP can be reduced.

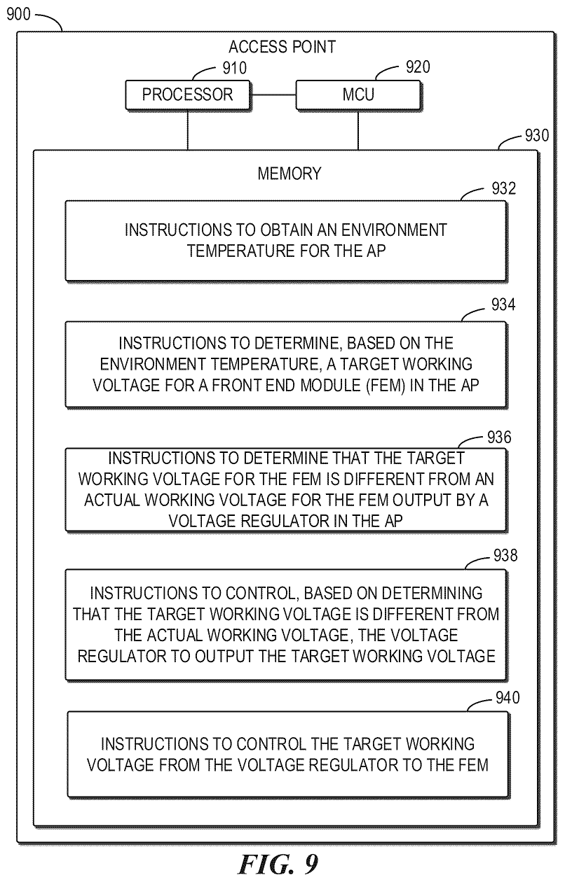

FIG. 9 illustrates an example AP 900 according to implementations of the present disclosure. As shown in FIG. 9, the AP 900 comprises at least one processor 910, an MCU 920, and a memory 930 coupled to the processor 910 and the MCU 930. The memory 930 stores instructions 932, 934, 936, 938, and 940 to cause the processor 910 or the MCU 920 to perform actions according to reference implementations of the present disclosure.

As shown in FIG. 9, the memory 930 stores instructions 932 to obtain an environment temperature for the AP. The memory 930 further stores instructions 934 to determine, based on the environment temperature, a target working voltage for a front end module (FEM) in the AP. Moreover, the memory 930 further stores instructions 936 to determine that the target working voltage for the FEM is different from an actual working voltage for the FEM output by a voltage regulator in the AP. The memory 930 further stores instructions 938 to control, based on determining that the target working voltage is different from the actual working voltage, the voltage regulator to output the target working voltage. As shown in FIG. 9, the memory 930 further stores instructions 940 to control the target working voltage from the voltage regulator to the FEM.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

Program codes or instructions for carrying out methods of the present disclosure may be written in any combination of one or more programming languages. These program codes or instructions may be provided to a processor or controller of a general-purpose computer, special-purpose computer, or other programmable data processing apparatus, such that the program codes, when executed by the processor or controller, cause the functions/operations specified in the flowcharts and/or block diagrams to be implemented. The program code or instructions may execute entirely on a machine, partly on the machine, as a stand-alone software package, partly on the machine and partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but is not limited to an electronic, magnetic, optical, electromagnetic, infrared, or semiconductor system, apparatus, device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order or that all illustrated operations be performed to achieve desirable results. In certain circumstances, multitasking and parallel processing may be advantageous. Certain features that are described in the context of separate implementations may also be implemented in combination in a single implementation. Conversely, various features that are described in the context of a single implementation may also be implemented in multiple implementations separately or in any suitable sub-combination.

In the foregoing Detailed Description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

What is claimed:

1. A method comprising:
obtaining, by an access point (AP), an environment temperature for the AP;
determining, by the AP and based on the environment temperature, a target working voltage for a front end module (FEM) in the AP;
determining, by the AP, that the target working voltage for the FEM is different from an actual working voltage for the FEM output by a voltage regulator in the AP;
controlling, by the AP and based on determining that the target working voltage is different from the actual working voltage, the voltage regulator to output the target working voltage; and
controlling, by the AP, the target working voltage from the voltage regulator to the FEM.

2. The method according to claim 1, wherein the determining the target working voltage for the FEM in the AP comprises:
obtaining a mapping related to temperatures and working voltages; and
determining, based on the mapping and the environment temperature, the target working voltage for the FEM.

3. The method according to claim 2, wherein the mapping is a mapping between a plurality of temperature ranges and a plurality of working voltages, and the determining, based on the mapping and the environment temperature, the target working voltage for the FEM comprises:
determining a temperature range of the plurality of temperature ranges including the environment temperature; and
determining a working voltage of the plurality of working voltages corresponding to the temperature range as the target working voltage for the FEM.

4. The method according to claim 1, wherein the controlling the voltage regulator to output the target working voltage comprises:
determining a feedback voltage provided to the voltage regulator; and
adjusting, based on determining that the target working voltage is different from the actual working voltage, the feedback voltage to control the voltage regulator to output the target working voltage.

5. The method according to claim 4, wherein the adjusting the feedback voltage to control the voltage regulator to output the target working voltage comprises:
reducing, based on determining that the target working voltage is higher than the actual working voltage, a feedback voltage provided to the voltage regulator; and
controlling, based on the reduced feedback voltage, the voltage regulator to increase the actual working voltage to the target working voltage.

6. The method according to claim 5, wherein the adjusting the feedback voltage to control the voltage regulator to output the target working voltage further comprises:
increasing, based on determining that the target working voltage is lower than the actual working voltage, the feedback voltage provided to the voltage regulator;
controlling, based on the increased feedback voltage, the voltage regulator to reduce the actual working voltage to the target working voltage.

7. The method according to claim 4, wherein the AP comprises a voltage detection unit, and the determining a feedback voltage provided to the voltage regulator comprises:
detecting the feedback voltage provided to the voltage regulator with the voltage detection unit.

8. The method according to claim 7, wherein the AP further comprises a voltage output unit, and the method further comprises:
connecting the voltage output unit to the voltage detection unit; and
adjusting an output voltage of the voltage output unit to the detected feedback voltage.

9. The method according to claim 8, wherein the voltage detection unit is an analog-to-digital converter, and the voltage output unit is a digital-to-analog converter.

10. The method according to claim 8, wherein the adjusting the feedback voltage to control the voltage regulator to output the target working voltage comprises:
control the voltage output unit to adjust the feedback voltage provided to the voltage regulator.

11. An access point (AP) comprising:
at least one processor;
a Microcontroller Unit (MCU);
a memory coupled to the at least one processor and the MCU, the memory storing instructions to cause the at least one processor to:
obtain an environment temperature for the AP;
determine, based on the environment temperature, a target working voltage for a front end module (FEM) in the AP; and
wherein the instructions further comprise instructions to cause the MCU to:
determine that the target working voltage for the FEM is different from an actual working voltage for the FEM output by a voltage regulator in the AP;
control, based on determining that the target working voltage is different from the actual working voltage, the voltage regulator to output the target working voltage; and
control the target working voltage from the voltage regulator to the FEM.

12. The AP according to claim 11, wherein the instructions to determine the target working voltage for the FEM in the AP comprise instructions to cause at least one processor to:
obtain a mapping related to temperatures and working voltages; and
determine, based on the mapping and the environment temperature, the target working voltage for the FEM.

13. The AP according to claim 11, wherein the mapping is a mapping between a plurality of temperature ranges and a plurality of working voltages, and the instructions to determine, based on the mapping and the environment temperature, the target working voltage for the FEM comprise instructions to cause the at least one processor to:
determine a temperature range of the plurality of temperature ranges including the environment temperature; and
determine a working voltage of the plurality of working voltages corresponding to the temperature range as the target working voltage for the FEM.

14. The AP according to claim 11, wherein the instructions to control the voltage regulator to output the target working voltage comprise instructions to cause the MCU to:
determine a feedback voltage provided to the voltage regulator; and
adjust, based on determining that the target working voltage is different from the actual working voltage, the feedback voltage to control the voltage regulator to output the target working voltage.

15. The AP according to claim 14, the instructions to adjust the feedback voltage to control the voltage regulator to output the target working voltage comprise instructions to cause the MCU to:
reduce, based on determining that the target working voltage is higher than the actual working voltage, a feedback voltage provided to the voltage regulator; and
control, based on the reduced feedback voltage, the voltage regulator to increase the actual working voltage to the target working voltage.

16. The AP according to claim 15, the instructions to adjust the feedback voltage to control the voltage regulator to output the target working voltage further comprise instructions to cause the MCU to
increase, based on determining that the target working voltage is lower than the actual working voltage, the feedback voltage provided to the voltage regulator;
control, based on the increased feedback voltage, the voltage regulator to reduce the actual working voltage to the target working voltage.

17. The AP according to claim 14, wherein the MCU comprises a voltage detection unit, and the instructions to determine a feedback voltage provided to the voltage regulator comprise instructions to cause the MCU to:
detect the feedback voltage provided to the voltage regulator with the voltage detection unit.

18. The AP according to claim 17, wherein the MCU further comprises a voltage output unit, and the instructions further comprises instructions to cause the MCU to:
connect the voltage output unit to the voltage detection unit; and
adjust an output voltage of the voltage output unit to the detected feedback voltage.

19. The AP according to claim 18, wherein the voltage detection unit is an analog-to-digital converter, and the voltage output unit is a digital-to-analog converter.

20. A non-transitory computer-readable medium comprising instructions stored thereon which, when executed by an access point (AP), cause the AP to:
obtain an environment temperature for the AP;
determine, based on the environment temperature, a target working voltage for a front end module (FEM) in the AP;
determine that the target working voltage for the FEM is different from an actual working voltage for the FEM output by a voltage regulator in the AP;
control, based on determining that the target working voltage is different from the actual working voltage, the voltage regulator to output the target working voltage; and
control the target working voltage from the voltage regulator to the FEM.
